(19) United States
(12) Patent Application Publication
(10) Pub. No.: US 2007/0024978 A1
(43) Pub. Date: Feb. 1, 2007

(54) Conformal beam steering devices having a minimal volume and window area utilizing risley prisms and diffraction gratings

(76) Inventors: John E. Jackson, Carol Stream, IL (US); Christopher B. Svec, Palatine, IL (US)

Correspondence Address: STETINA BRUNDA GARRED & BRUCKER, 75 ENTERPRISE, SUITE 250, ALISO VIEJO, CA, 92656, US

(21) Appl. No.: 11/194,241

(22) Filed: Aug. 1, 2005

(51) Int. Cl. G02B 5/18

(52) U.S. Cl. 359/569; 359/573

(57) ABSTRACT

A conformal beam steering device is provided which is adapted to steer an LOS beam from a broad spectrum over a significantly large FOR. The device size is optimized to have a minimal volume and output window footprint. The device includes a first prism positioned inboard a second prism, a diffraction grating on an outboard side of the first prism, and a diffraction grating on an inboard side of the second prism. Another embodiment includes a first prism positioned inboard a second prism, a first linear diffraction grating positioned inboard the first prism, the first linear diffraction grating having a grating disposed on an outboard side thereof, and a second linear diffraction grating positioned in between the first linear diffraction grating and the first prism, the second linear diffraction grating having a grating disposed on an inboard side thereof. And yet another embodiment includes a first prism positioned inboard a second prism, and a variable pitch linear diffraction grating positioned inboard the first prism, wherein the diffraction grating has a grating disposed on an outboard side thereof. The prisms are preferably formed from a substrate material comprising KRS5.

### STATEMENT RE: FEDERALLY SPONSORED RESEARCH/DEVELOPMENT

The present invention was developed under U.S. Government Contract No.F33615-020-D-1143 0002

### CROSS-REFERENCE TO RELATED APPLICATIONS

Not Applicable

### BACKGROUND OF THE INVENTION

1. Field of the Invention

The present invention relates to beam steering devices designed to conformally fit or to be flushly integrated with the outer surface of a body of a vehicle such as an aircraft, spacecraft, missile or the like. In particular, the present invention relates to a system and/or apparatus for steering a line of sight broad spectrum beam over a significantly large field of regard (FOR) requiring a minimum of volume and output window footprint area by utilizing various combinations of Risley prisms and diffraction gratings

2. Background of the Invention

Precise and controllable delivery of laser beams to a desired location is an important technology with respect to telecommunications, military, and other general industrial applications. The most common means of obtaining such delivery is the use of large (i.e. macroscopic) mechanically controlled mirrors, lenses and gimbals to steer laser beams. While this technology is mature, it is limited by the mechanical nature of mirror movement. Furthermore, inertial properties of mechanically driven mirrors limit the speed with which steering can be changed.

There are numerous new beam-steering applications which have been identified; however, current beam steering technology does not exist to support such identified applications. For instance, in the near term, new technologies for beam steering systems must facilitate self-protection [techniques-based infrared countermeasures (IRCM)], targeting, passive and active searching and tracking, and free-space optical (FSO) communications. These systems must accommodate, in the longer term, damage-and-degrade-based (D²) infrared countermeasures. The new beam-steering technologies must also be “conformal” to the outer skin of a vehicle, such as an aircraft, in order to reduce aerodynamic drag, reduce radar cross section, and minimize the obscuration to adjacent electro-optic (EO) systems.

These aforementioned emerging approaches are often referred to as “non-gimbal based” technologies. Numerous approaches have been funded through government programs including STAB (“Steered Agile Beams”), MEDUSA (“Multi-function Electro-Optics for Defense of US Aircraft”), THOR (TeraHertz Operational Reachback”), CCIT (Coherent Communications, Imaging, and Targeting”). Approaches involving rotating-prisms, flexible waveguides, liquid-crystals (LC), MEMs-based deformable mirrors (DM), acousto-optics, and other technologies are also presently being funded.

Among both known and emerging approaches, none presently meet or are forecasted to meet the following stringent specifications, within reasonable size, weight, and power requirements (SWAP): (1) wherein the sum of the windows used in the total system is about 200 in²; (2) wherein the cylindrical volume of each separate conformal beam steering device is less than about 500 cm³; and (3) wherein the window diameter is under 150 mm.

The technology that appears to be the most promising with regard to meeting the aforementioned stringent requirements (sum of the window area, window diameter, cylindrical volume) is a rotating prisms concept, which utilizes two prisms (known as a Risley pair) that rotate with respect to each other. However, this approach at first take appears not desirable because the system is not entirely reflective, and as a result, there is a pointing error among different colors of the spectrum. To overcome this problem, previous attempts at using rotating prisms attempted to achromatize the prisms with other broad-spectrum optical materials, however, there are not many acceptable materials to choose from in the 0.75 μm to 10 μm spectrum. The resulting solution was an order of magnitude larger volume than desired. Furthermore, the output window footprint required was also an order of magnitude larger area than desired, making it very unattractive for tactical applications.

Nevertheless, even though prior attempts of using rotating prisms for conformal beam steering have not been that successful, rotating prisms still appear to a leading technology which will provide a conformal system having a minimum window area and cylindrical volume. Thus, it would be advantageous to provide a conformal beam steering device or apparatus which overcomes the reflectivity and pointing disadvantages which still appear to be holding back the rotating prism approach to conformal beam steering systems. Overall, in order to support multifunctional electro-optical missions, it would be advantageous and desirable to provide an ideal beam-steering device which utilizes rotating prisms that would be conformal, has a minimum window area, and a minimum cylindrical volume. Additionally, it would be advantageous to package the entire optical device into a modular configuration such that it will meet specific modularity requirements set forth for upcoming military programs and perhaps commercial applications.

### BRIEF SUMMARY OF THE INVENTION

The present invention is intended to overcome and solve the aforementioned problems commonly encountered with beam steering devices which utilize rotating prisms. Furthermore, the present invention provides better performance characteristics than any previously known or published approaches.

According to an embodiment of the present invention, a conformal beam steering device is provided which is adapted to steer a line of sight beam from a broad spectrum over a significantly large field of regard (FOR). The size of the device is optimized to have a minimal volume and output window footprint area. The beam steering device comprises a first prism positioned inboard a second prism to form a Risley pair of prisms; a diffraction grating formed on an outboard side of the first prism; and a diffraction grating formed on an inboard side of the second prism. The Risley pair of prisms are adapted to be independently rotated about a common axis to change a line of sight (LOS) through both of the prisms such that a boresight of two widely separated wavelengths within the broad spectrum are achromatically corrected optimally over the FOR. According to an aspect of the present invention, the pair of prisms are preferably formed from a substrate material comprising KRS5.

According to another aspect of the present invention, each of the pair of prisms may be isosceles prisms. According to another aspect of the present invention, each of the pair of prisms are right triangle prisms defined by a hypotenuse side, an adjacent side parallel to the common axis, and an opposite side normal to the common axis. In another aspect of the present invention, the opposite side of each right triangle is positioned outboard the hypotenuse side.

According to another aspect of the present invention, the first prism is an isosceles prism and the second prism is a right triangle prism defined by a hypotenuse side, an adjacent side parallel to the common axis, and an opposite side normal to the common axis. In another aspect of the present invention, the opposite side of the right triangle is positioned outboard the hypotenuse side.

According to another aspect of the present invention, the device includes a broad spectrum beam source. And, according to another aspect of the present invention, the device further includes a window adapted to be conformally integrated with the skin or body of a vehicle, wherein the window is arranged normal to the common axis.

According to an alternative embodiment of the present invention, a conformal beam steering device is provided which is adapted to steer a line of sight beam from a broad spectrum over a significantly large field of regard (FOR). The size of the device is optimized to have a minimal volume and output window footprint area. The beam steering device comprises a first prism positioned inboard a second prism to form a Risley pair of prisms; a first linear diffraction grating positioned inboard the first prism, the first linear diffraction grating having a grating surface disposed on an outboard side thereof; and a second linear diffraction grating positioned in between the first linear diffraction grating and the first prism, the second linear diffraction grating having a grating surface disposed on an inboard side thereof. The Risley pair of prisms are adapted to be independently rotated about a common axis to steer a field of view (FOV) of the device through the FOR. The linear diffraction gratings are adapted to be independently rotated about the common axis so that the boresight of two widely separated wavelengths within the broad spectrum are achromatically corrected optimally over the FOR. According to another aspect of the present invention, the pair of prisms are preferably formed from a substrate material comprising KRS5.

According to another aspect of the present invention, each of the pair of prisms may be isosceles prisms. According to another aspect of the present invention, each of the pair of prisms may be right triangle prisms defined by a hypotenuse side, an adjacent side parallel to the common axis, and an opposite side normal to the common axis. According to an aspect of the present invention, the opposite side of each right triangle is positioned outboard the hypotenuse side. In another aspect of the present invention, the first prism may be an isosceles prism and the second prism being a right triangle prism defined by a hypotenuse side, an adjacent side parallel to the common axis, and an opposite side normal to the common axis. And yet in another aspect of the present invention, the opposite side of the right triangle is positioned outboard the hypotenuse side.

According to another aspect of the present invention, the device of the second embodiment may also include a broad spectrum beam source. And still further, according to another aspect of the present invention, the device of the second embodiment may also include a window adapted to be conformally integrated with the skin or body of a vehicle, wherein the window is arranged normal to the common axis.

And another alternative embodiment of the present invention provides a conformal beam steering device adapted to steer a line of sight beam from a broad spectrum over a significantly large field of regard (FOR). The size of the device is optimized to have a minimal volume and output window footprint area. The beam steering device comprises a first prism positioned inboard a second prism to form a Risley pair of prisms; and a variable pitch linear diffraction grating positioned inboard the first prism, wherein the diffraction grating has a grating surface disposed on an outboard side thereof. The Risley pair of prisms are adapted to be independently rotated about a common axis to steer a field of view (FOV) of the device through the FOR. Further, the variable pitch diffraction grating is adapted to be independently rotated about the common axis while also being electrically addressed so that the boresight of two widely separated wavelengths within the broad spectrum are achromatically corrected optimally over the FOR. Moreover, the pair of prisms are preferably formed from a substrate material comprising KRS5.

Additionally, another aspect of the present invention is that each of the pair of prisms may be isosceles prisms. According to another aspect of the present invention, each of the pair of prisms may be right triangle prisms defined by a hypotenuse side, an adjacent side parallel to the common axis, and an opposite side normal to the common axis. In another aspect of the present invention, the opposite side of each right triangle is positioned outboard the hypotenuse side. And according to yet another aspect of the present invention, the first prism may be an isosceles prism and the second prism may be a right triangle prism defined by a hypotenuse side, an adjacent side parallel to the common axis, and an opposite side normal to the common axis. Moreover, according to another aspect of the present invention, the opposite side of the right triangle is positioned outboard the hypotenuse side.

Moreover, according to another aspect of the present invention, the device of the third embodiment may include a broad spectrum beam source. Furthermore, according to another aspect of the present invention, the device of the third embodiment may further include a window adapted to be conformally integrated with the skin or body of a vehicle, wherein the window is arranged normal to the common axis.

Other exemplary embodiments and advantages of the present invention may be ascertained by reviewing the present disclosure and the accompanying drawings.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 provides a first exemplary embodiment of a conformal beam steering device, and in particular, a Diffraction Grating Risley Prism Achromatic Beam Steerer [DGRPABS] which utilizes a pair of isosceles prisms, wherein each prism has a diffraction grating formed on a surface thereof, according to an aspect of the present invention;

FIG. 2 provides a second exemplary embodiment of a conformal beam steering device, and in particular, a Diffraction Grating Risley Prism Achromatic Beam Steerer [DGRPABS] which utilizes a pair of right triangle prisms, wherein each prism has a diffraction grating formed on a surface thereof, according to an aspect of the present invention;

FIG. 3 provides a third exemplary embodiment of a beam steering device, and in particular, a Diffraction Grating Risley Prism Achromatic Beam Steerer [DGRPABS] which utilizes one isosceles prism in combination with a right triangle prism, wherein each prism has a diffraction grating formed on a surface thereof, according to an aspect of the present invention;

FIG. 4 provides a ZEMAX model of the DGRPABS from FIG. 1 with three different configurations superimposed and the resultant beams thereof, according to an aspect of the present invention;

FIG. 5 provides a fourth exemplary embodiment of a beam steering device, and in particular, an Achromatic Correcting, Rotatable Diffraction Grating+Risley Beam Steerer [ACRDGRPBS] which utilizes a pair of isosceles prisms in combination with a pair of linear diffraction gratings, according to an aspect of the present invention;

FIG. 6 provides a fifth exemplary embodiment of a beam steering device, and in particular, an Achromatic Correcting, Rotatable Diffraction Grating+Risley Beam Steerer [ACRDGRPBS] which utilizes a separate pair of right triangle prisms in combination with a separate pair of linear diffraction gratings, according to an aspect of the present invention;

FIG. 7 provides a sixth exemplary embodiment of a beam steering device, and in particular, an Achromatic Correcting, Rotatable Diffraction Grating+Risley Beam Steerer [ACRDGRPBS] which utilizes an isosceles prism in combination with a right triangle prism in combination with a pair of linear diffraction gratings, according to an aspect of the present invention;

FIG. 8 provides a ZEMAX model of the ACRDGRPBS from FIG. 6 with three different configurations superimposed and the resultant beams thereof, according to an aspect of the present invention;

FIG. 9 provides a seventh exemplary embodiment of a beam steering device, and in particular, Rotatable Variable Diffraction Grating Risley Prism Achromatic Beam Steerer [RVDGRPABS] which utilizes a pair of isosceles prisms in combination with a separate variable-pitch, linear diffraction grating, according to an aspect of the present invention;

FIG. 10 provides a eighth exemplary embodiment of a beam steering device, and in particular, Rotatable Variable Diffraction Grating Risley Prism Achromatic Beam Steerer [RVDGRPABS] which utilizes a pair of right triangle prisms in combination with a separate variable-pitch, linear diffraction grating, according to an aspect of the present invention;

FIG. 11 provides a ninth exemplary embodiment of a beam steering device, and in particular, Rotatable Variable Diffraction Grating Risley Prism Achromatic Beam Steerer [RVDGRPABS] which utilizes an isosceles prism in combination with a right triangle prism in combination with a separate variable-pich, linear diffraction grating, according to an aspect of the present invention; and

FIG. 12 provides a ZEMAX model of the RVDGRPABS from FIG. 10 with three different configurations superimposed and the resultant beams thereof, according to an aspect of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The present invention provides various embodiments of a conformal beam steering device and/or apparatus which overcomes the reflectivity and pointing disadvantages experienced with rotating Risley prism conformal beam steering devices. In order to support multifunctional electro-optical missions, a beam-steering device is provided which utilizes rotating Risley prisms in combination with diffraction gratings. Furthermore, research and testing has identified KRS5 as a preferred substrate material. As a result, a conformal beam steering device is provided which may be packaged in relatively small space and of which has a small window area.

In particular, with respect to size the present invention has a Z depth of about 50 mm, a diameter of about 88.2 mm, a cylindrical volume of about 306 cm³, a window diameter of about 108 mm, and an average sum of the window area of about 170 in². Therefore, the present invention appears to be the most space efficient conformal beam steerer reduced to practice which is acceptable for tactical operations. Thus, the present invention currently appears to meet the stringent and specific modularity requirements set forth for upcoming military programs.

As already discussed, the aforementioned efficient packaging of the present invention conformal beam steerer is accomplished by utilizing Risley prism pairs in combination with various diffraction grating arrangements. To overcome the reflectivity and pointing issues which have plagued Risley prism beam steering devices before, the diffraction gratings address wide band requirements by slaving wavelengths λ1 to λ4 while the prism material (preferably KRS5) has been chosen to provide the minimum boresight at the other wavelengths compared to λ4. For instance, in one embodiment which utilizes two diffraction gratings, the transmission diffraction gratings address wide band requirements by slaving wavelengths λ1 to μ4 and μ5 to λ4 while the prism material is chosen to provide the minimum boresight at the other wavelengths compared to λ4. The end result is a conformal beam steering device which is not only compact in size, but of which has a ground tracing efficiency of about 90%.

One aspect of the present invention is that it accomplishes the efficient packaging parameters in various manners using differing Risley prism shapes. The prism shapes used in the various embodiments of the present invention are either a pair of isosceles triangles, a pair of right triangles, or a isosceles triangle paired with and right triangle. The aforementioned combinations of Risley prism pairs have proven to minimize aperture truncation.

Another aspect of the present invention is that it uses either fixed or variable diffraction gratings. The gratings may be formed on separate rotatable substrates or on the prism surfaces. It has been found that a variable diffraction grating on a separate rotatable substrate can completely correct the boresight of two wavelengths over the full FOR. It is further noted that it is preferred that the diffraction gratings are coupled together or arranged together, one on an inboard side and the other on a outboard side of the substrate. Such an arrangement for the diffraction gratings will be discussed in further detail later in the specification.

Of sixteen potential broadband materials, KRS5 has been identified as having the lowest dispersion for the wavelength separations of interest. Other substrate materials which could be possibly used, but of which are not considered as promising include CaF, As2S3, BaF2, CsBr to name a few. A manufacturer of KRS5 is Crystran Ltd. (see www.crystran.co.uk). Crystran may further provide prisms with diffraction gratings already formed on the prism substrate. More information on the optical properties of KRS5 may be found in SPIE, volume 3060, pages 344-355 (1997).

Diffraction Grating Risley Prism Achromatic Beam Steerer [DGRPABS]

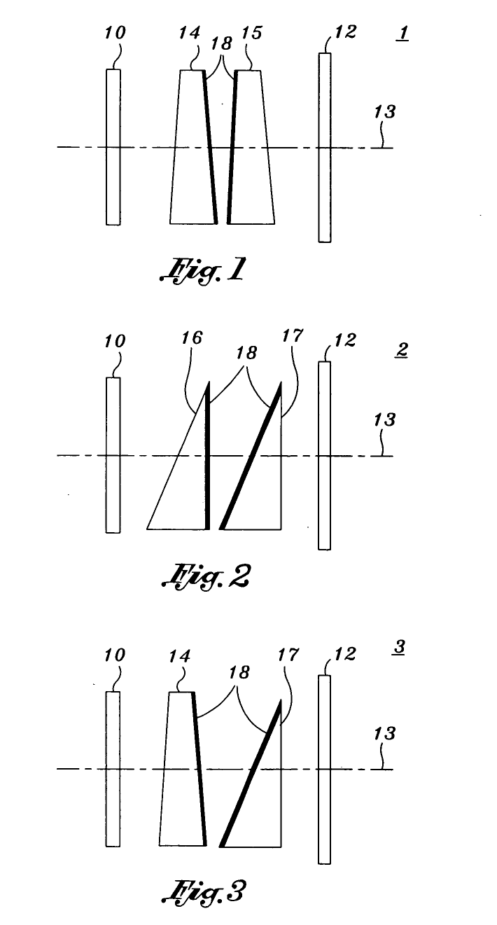

FIGS. 1 through 3 provide several embodiments of an exemplary Diffraction Grating Risley Prism Achromatic Beam Steerer [DGRPABS], according to an aspect of the present invention. The DGRPABS is adapted to steer a line of sight from broad spectrum source over a significantly large field of regard (FOR). The DGRPABS also requires a minimum of volume and output window footprint area compared to other beam steering solutions. The DGRPABS is comprised of two Risley prisms which are independently rotated axially to change the line of sight (LOS) through both of them. A diffraction grating is formed on one optical surface of each, such that the boresight of two widely separated wavelengths within the broad spectrum are achromatically corrected optimally over the FOR. The substrate material KRS5 is selected to provide a minimum of chromatic boresight error over the rest of the spectrum. The following paragraphs will now describe each individual embodiment of the DGRPABS.

FIG. 1 provides a first exemplary embodiment 1 of a conformal beam steering device, and in particular, a Diffraction Grating Risley Prism Achromatic Beam Steerer [DGRPABS] which utilizes a pair of isosceles prisms 14, 15, wherein each prism has a diffraction grating 18 formed on a surface thereof, according to an aspect of the present invention. In particular, the diffraction gratings 18 are formed on the outboard side of the inboard prism 14 and the inboard side of the outboard prism 15. The beam steering device also may include a beam source 10 positioned inboard the prisms. Also, the beam steering device may include a window 12 positioned outboard the prisms which is intended to be conformally mounted (i.e., flush) with the skin of the vehicle.

FIG. 2 provides a second exemplary embodiment 2 of a conformal beam steering device, and in particular, a Diffraction Grating Risley Prism Achromatic Beam Steerer [DGRPABS] which utilizes a pair of right triangle prisms 16, 17, wherein each prism has a diffraction grating 18 formed on a surface thereof, according to an aspect of the present invention. In particular, the diffraction gratings 18 are formed on the outboard side of the inboard prism 16 and the inboard side of the outboard prism 17. The beam steering device also may include a beam source 10 positioned inboard the prisms. And the beam steering device may also include a window 12 positioned outboard the prisms which is intended to be conformally mounted (i.e., flush) with the skin of the vehicle.

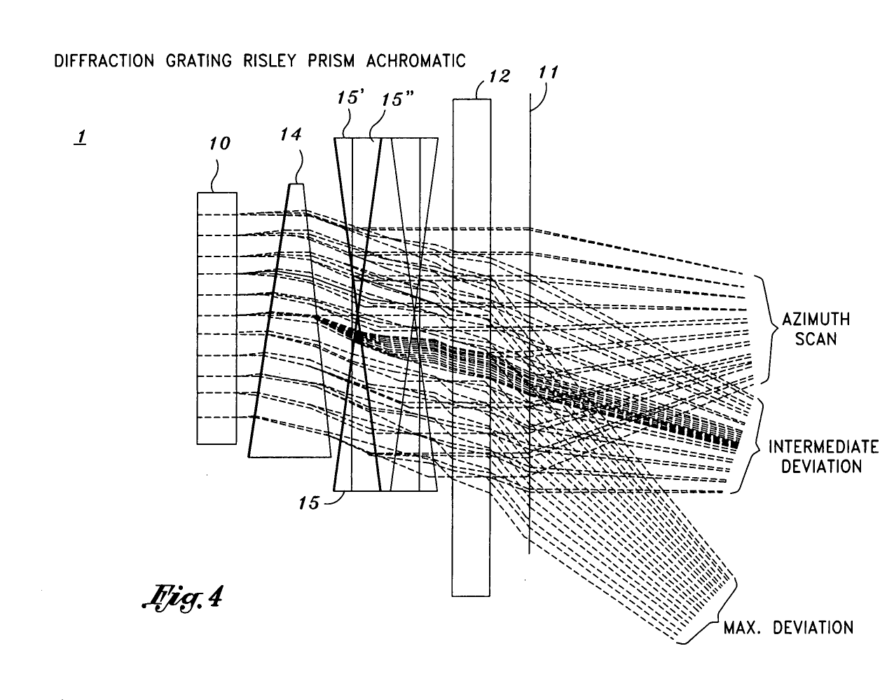

FIG. 3 provides a third exemplary embodiment 3 of a beam steering device, and in particular, a Diffraction Grating Risley Prism Achromatic Beam Steerer [DGRPABS] which utilizes one isosceles prism 14 in combination with a right triangle prism 17, wherein each prism has a diffraction grating 18 formed on a surface thereof, according to an aspect of the present invention. In particular, the diffraction gratings 18 are formed on the outboard side of the inboard prism 14 and the inboard side of the outboard prism 17. The beam steering device also may include a beam source 10 and a window 12 positioned outboard of the prisms which is intended to be conformally mounted (i.e., flush) with the skin of the vehicle.

FIG. 4 provides a ZEMAX model of the DGRPABS from FIG. 1 with three different configurations superimposed and the resultant beams thereof, according to an aspect of the present invention. In particular, the ZEMAX model predicts the resultant beam with respect to a hypothetical paraxial lens 11 positioned outboard the window 12. The DGRPABS is modeled in four different configurations including maximum deviation, zero deviation, intermediate deviation and an azimuth scan. Maximum deviation occurs when the pointed ends of inboard prism 14 and outboard prism 15 are facing the same direction. As can be seen from FIG. 4, the resultant beam at maximum deviation is turned or steered at the most acute angle with respect to the paraxial lens 11. Zero deviation occurs when the pointed end of the inboard prism 14 faces in an opposite direction of the outboard prism 15 (see position 15′). The resultant beam (not shown) is basically straight out of the beam steering device similar to the manner in which the beam is originally emitted from the beam source 10. Thus, the zero deviation beam is emitted normal to the paraxial lens 11. Intermediate deviation occurs when the pointed end of the inboard prism is configured ninety degrees from the pointed end of the outboard prism 15 (see position 15″ which shows the wide end of the outboard prism 15). As can be see from FIG. 4, the resultant beam at intermediate deviation is turned or steered less acutely than the maximum deviation resultant beam. Finally, an azimuth scan occurs when the pointed ends of the inboard prism 14 and outboard prism 15 are facing the same direction (similar to the maximum deviation configuration) and when both of the prisms 14, 15 are rotating in unison or together about the axis of rotation. The resultant beam azimuth scan beam is frusto-conical shaped.

Achromatic Correcting Rotatable Diffraction Gratings Risley Prism Achromatic Beam Steerer [ACRDGRPBS]

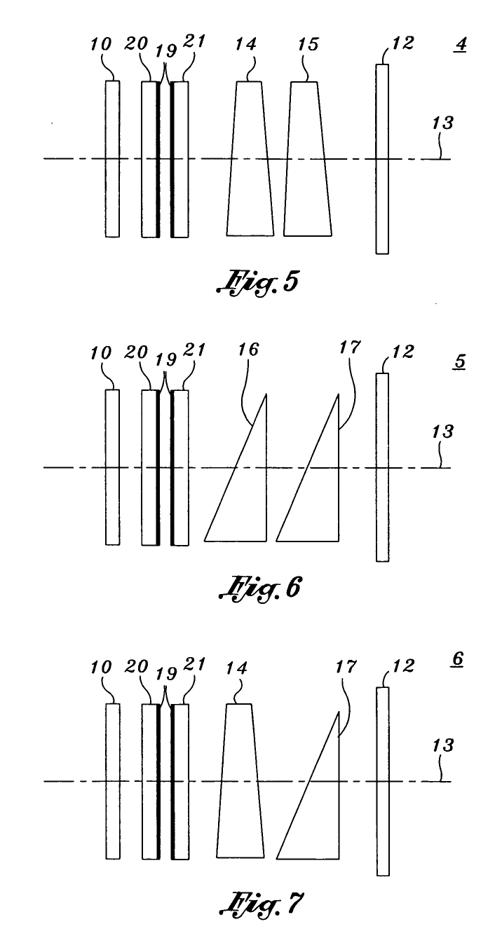

FIGS. 5 through 7 provide several embodiments an exemplary Achromatic Correcting Rotatable Diffraction Gratings Risley Prism Achromatic Beam Steerer [ACRDGRPBS], according to an aspect of the present invention. The ACRDGRPBS is adapted to steer a line of sight from a broad spectrum source over a significantly large field of regard (FOR). The ACRDGRPB also requires a minimum of volume and output window footprint area compared to other beam steerer solutions. The ACRDGRPBS is comprised of two prisms and two separate linear diffraction gratings, which are all independently rotated axially. The prisms are rotated to steer the FOV through the FOR, while the diffraction gratings are rotated so that the boresight of two widely separated wavelengths within the broad spectrum are achromatically corrected optimally over the FOR. The substrate material KRS5 is selected to provide a minimum of chromatic boresight error over the rest of the spectrum.

FIG. 5 provides a fourth exemplary embodiment 4 of a beam steering device, and in particular, an Achromatic Correcting, Rotatable Diffraction Grating+Risley Beam Steerer [ACRDGRPBS] which utilizes a pair of isosceles prisms 14, 15 in combination with a pair of linear diffraction gratings 20, 21, according to an aspect of the present invention. In particular, the pair of linear diffraction gratings (LDG) 20, 21 are positioned inboard of the pair of isosceles prisms 14, 15, wherein gratings 19 are formed on the outboard side of LDG 20 and on the inboard side of the outboard LDG 21. The beam steering device also may include a beam source 10 positioned inboard the diffraction gratings 20, 21. Also the beam steering device may include a window 12 positioned outboard the prisms which is intended to be conformally mounted (i.e., flush) with the skin of the vehicle.

FIG. 6 provides a fifth exemplary embodiment 5 of a beam steering device, and in particular, an Achromatic Correcting, Rotatable Diffraction Grating+Risley Beam Steerer [ACRDGRPBS] which utilizes a pair of right triangle prisms 16, 17 in combination with a pair of linear diffraction gratings 20, 21, according to an aspect of the present invention. In particular, the pair of linear diffraction gratings (LDG) 20, 21 are positioned inboard of the pair of right triangle prisms 16, 17, wherein the gratings 19 are formed on the outboard side of LDG 20 and on the inboard side of the outboard LDG 21. The beam steering device also may include a beam source 10 positioned inboard the pair of diffraction gratings 20, 21. Also the beam steering device may include a window 12 positioned outboard the prisms which is intended to be conformally mounted (i.e., flush) with the skin of the vehicle.

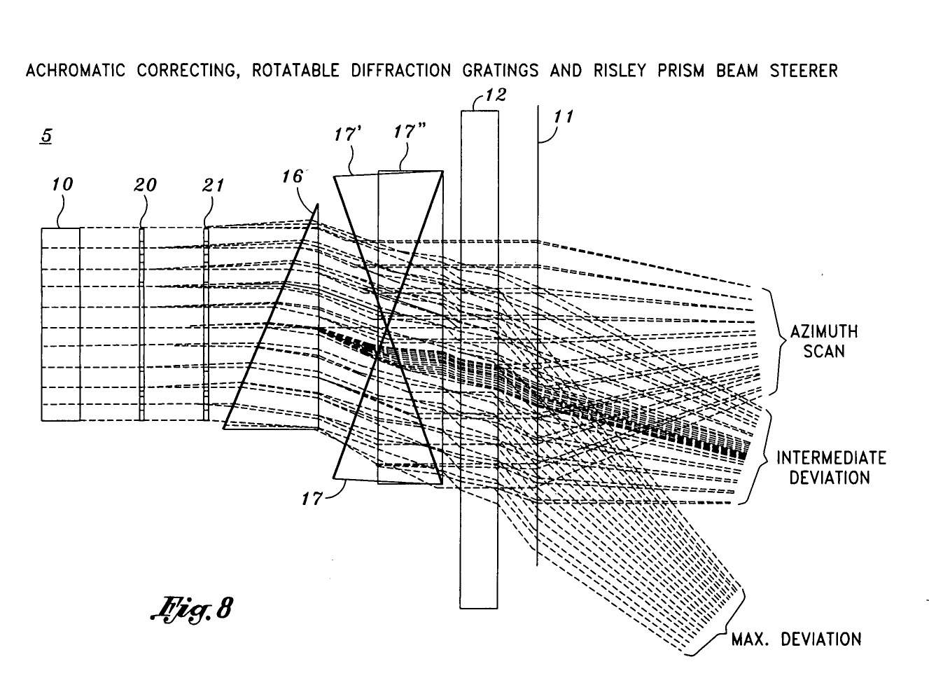

FIG. 7 provides a sixth exemplary embodiment 6 of a beam steering device, and in particular, an Achromatic Correcting, Rotatable Diffraction Grating+Risley Beam Steerer [ACRDGRPBS] which utilizes one isosceles prism 14 and a right triangle prism 17 in combination with a pair of linear diffraction gratings 20, 21, according to an aspect of the present invention. In particular, the pair of linear diffraction gratings (LDG) 20, 21 are positioned inboard of the pair of right triangle prisms 16, 17, wherein the gratings are formed on the outboard side of LDG 20 and on the inboard side of the outboard LDG 21. The beam steering device also may include a beam source 10 positioned inboard the pair of diffraction gratings 20, 21. Also, the beam steering device may include a window 12 positioned outboard the prisms which is intended to be conformally mounted (i.e., flush) with the skin of the vehicle.

FIG. 8 provides a ZEMAX model of the ACRDGRPBS from FIG. 6 with three different configurations superimposed and the resultant beams thereof, according to an aspect of the present invention. The ZEMAX model predicts that all chromatic error between two sufficiently separated wavelengths can be eliminated by the implementation of the rotatable gratings 20, 21. This result suggests that the limitations of the device would then rely on the resolution of the rotating mechanisms. In particular, the ZEMAX model predicts the resultant beam with respect to a hypothetical paraxial lens 11 positioned outboard the window 12. The ACRDGRPBS is modeled in four different configurations including maximum deviation, zero deviation, intermediate deviation and an azimuth scan. Maximum deviation occurs when the pointed ends of inboard prism 16 and outboard prism 17 are facing the same direction. As can be seen from FIG. 8, the resultant beam at maximum deviation is turned or steered at the most acute angle with respect to the paraxial lens 11. Zero deviation occurs when the pointed end of the inboard prism 16 faces in an opposite direction of the outboard prism 17 (see position 17′). The resultant beam (not shown) is basically straight out of the beam steering device similar to the manner in which the beam is originally emitted from the beam source 10. Thus, the zero deviation beam is emitted normal to the paraxial lens 11. Intermediate deviation occurs when the pointed end of the inboard prism 16 is configured ninety degrees from the pointed end of the outboard prism 17 (see position 17″ which shows the wide end of the outboard prism 17). As can be seen from FIG. 8, the resultant beam at intermediate deviation is turned or steered less acutely than the maximum deviation resultant beam. Finally, an azimuth scan occurs when the pointed ends of the inboard prism 16 and outboard prism 17 are facing the same direction (similar to the maximum deviation configuration) and when both of the prisms 16, 17 are rotating in unison or together about the axis of rotation. The resultant azimuth scan beam is frusto-conical shaped.

Rotatable Variable Diffraction Grating Risley Prism Achromatic Beam Steerer [RVDGRPABS]

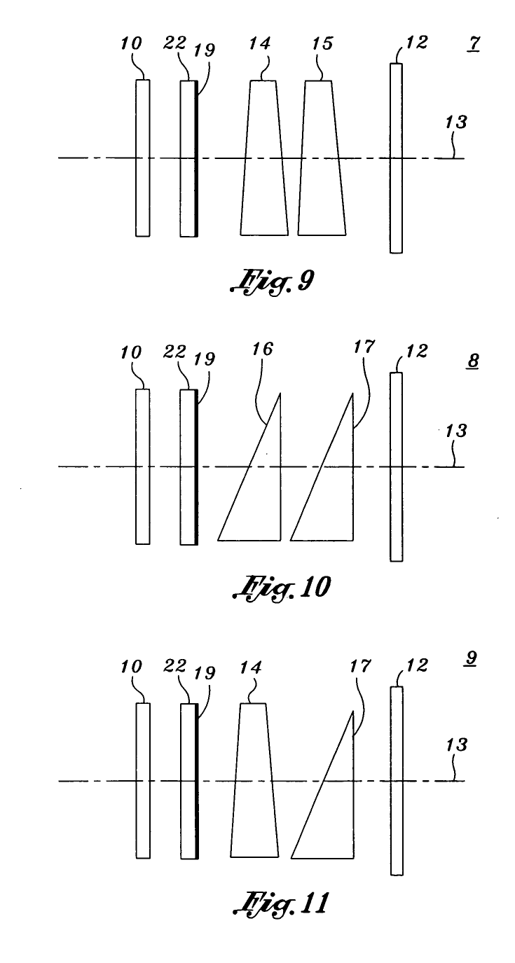

FIGS. 9 through 11 provide several embodiments an exemplary Rotatable Variable Diffraction Grating Risley Prism Achromatic Beam Steerer [RVDGRPABS], according to an aspect of the present invention. The RVGRPABS is adapted to steer a line of sight of broad spectrum by subject invention over a significantly large field of regard (FOR). The RVDGRPABS also requires a minimum of volume and output window footprint area compared to other beam steerer solutions. The RVDGRPABS is comprised of two prisms and a separate variable-pitch, linear diffraction grating, which are all independently rotated axially. The prisms are rotated to steer the FOV through the FOR, while the variable-pitch, linear diffraction grating is rotated and its pitch electrically addressed so that the boresight of two widely separated wavelengths within the broad spectrum are achromatically corrected optimally over the FOR. The substrate material KRS5 is selected to provide a minimum of chromatic boresight error over the rest of the spectrum.

FIG. 9 provides a seventh exemplary embodiment 7 of a beam steering device, and in particular, Rotatable Variable Diffraction Grating Risley Prism Achromatic Beam Steerer [RVDGRPABS] which utilizes a pair of isosceles prisms 14, 15 in combination with a separate variable-pitch, linear diffraction grating 22, according to an aspect of the present invention. In particular, the variable-pitch, linear diffraction grating (VPLDG) 22 is positioned inboard of the pair of isosceles prisms 14, 15, wherein the grating 19 is formed on the outboard side of VPLDG 22. The beam steering device also may include a beam source 10 positioned inboard the VPLDG 22. Also, the beam steering device may include a window 12 positioned outboard the prisms which is intended to be conformally mounted (i.e., flush) with the skin of the vehicle.

FIG. 10 provides an eighth exemplary embodiments of a beam steering device, and in particular, Rotatable Variable Diffraction Grating Risley Prism Achromatic Beam Steerer [RVDGRPABS] which utilizes a pair of right triangle prisms 16, 17 in combination with a separate variable-pitch, linear diffraction grating 22, according to an aspect of the present invention. In particular, the variable-pitch, linear diffraction grating (VPLDG) 22 is positioned inboard of the pair of right triangle prisms 16, 17, wherein the grating 19 is formed on the outboard side of VPLDG 22. The beam steering device also may include a beam source 10 positioned inboard the VPLDG 22. Also, the beam steering device may include a window 12 positioned outboard the prisms which is intended to be conformally mounted (i.e., flush) with the skin of the vehicle.

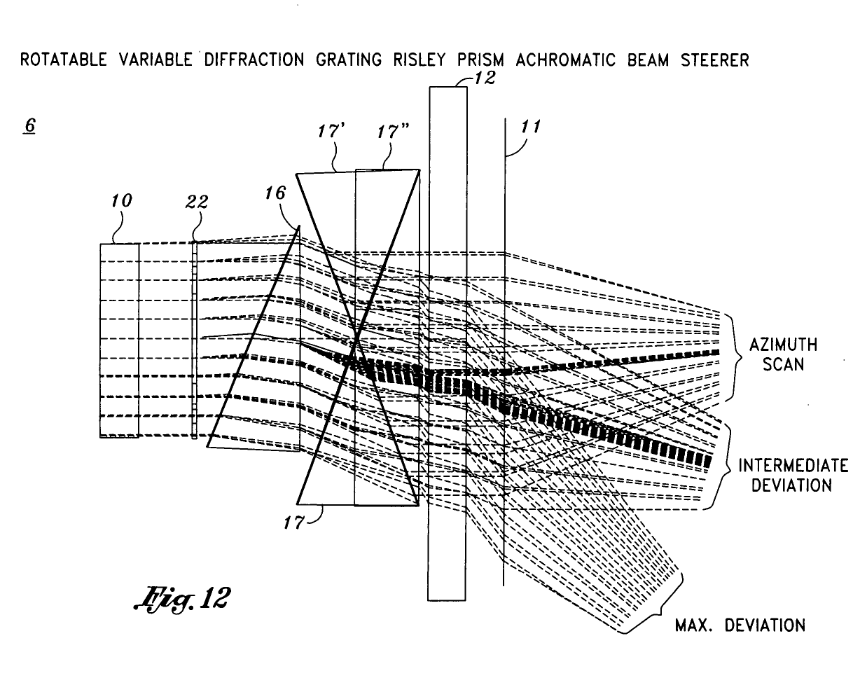

FIG. 11 provides a ninth exemplary embodiment 9 of a beam steering device, and in particular, Rotatable Variable Diffraction Grating Risley Prism Achromatic Beam Steerer [RVDGRPABS] which utilizes one isosceles prism 14 and a right triangle prism 17 in combination with a separate variable-pitch, linear diffraction grating 22, according to an aspect of the present invention. In particular, the variable-pitch, linear diffraction grating (VPLDG) 22 is positioned inboard of the isosceles prism 14 and right triangle prism 17, wherein the grating 19 is formed on the outboard side of VPLDG 22. The beam steering device also may include a beam source 10 positioned inboard the VPLDG 22. Also the beam steering device may include a window 12 positioned outboard the prisms which is intended to be conformally mounted (i.e., flush) with the skin of the vehicle.

FIG. 12 provides a ZEMAX model of the RVDGRPABS from FIG. 10 with three different configurations superimposed and the resultant beams thereof, according to an aspect of the present invention. The ZEMAX model predicts that all chromatic error between two sufficiently separated wavelengths can be eliminated by the implementation of the rotatable, electrically addressable grating. This result suggests that the limitations of the system would then rely on the resolution of the rotating mechanism combined with that of a compression stimulator creating the variable grating. In particular, the ZEMAX model predicts the resultant beam with respect to a hypothetical paraxial lens 11 positioned outboard the window 12. The RVDGRPABS is modeled in four different configurations including maximum deviation, zero deviation, intermediate deviation and an azimuth scan. Maximum deviation occurs when the pointed ends of inboard prism 16 and outboard prism 17 are facing the same direction. As can be seen from FIG. 12, the resultant beam at maximum deviation is turned or steered at the most acute angle with respect to the paraxial lens 11. Zero deviation occurs when the pointed end of the inboard prism 16 faces in an opposite direction of the outboard prism 17 (see position 17′). The resultant beam (not shown) is basically straight out of the beam steering device similar to the manner in which the beam is originally emitted from the beam source 10. Thus, the zero deviation beam is emitted normal to the paraxial lens 11. Intermediate deviation occurs when the pointed end of the inboard prism 16 is configured ninety degrees from the pointed end of the outboard prism 17 (see position 17″ which shows the wide end of the outboard prism 17). As can be seen from FIG. 12, the resultant beam at intermediate deviation is turned or steered less acutely than the maximum deviation resultant beam. Finally, an azimuth scan occurs when the pointed ends of the inboard prism 16 and outboard prism 17 are facing the same direction (similar to the maximum deviation configuration) and when both of the prisms 16, 17 are rotating in unison or together about the axis of rotation. The resultant azimuth scan beam is frusto-conical shaped.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and such uses are within the scope of the appended claims.

What is claimed is:

1. A conformal beam steering device adapted to steer a line of sight beam from a broad spectrum over a significantly large field of regard (FOR), the size of the device being optimized to have a minimal volume and output window footprint area, the beam steering device comprising:
a first prism positioned inboard a second prism to form a Risley pair of prisms;
a diffraction-grating formed on an outboard side of the first prism; and
a diffraction grating formed on an inboard side of the second prism;
wherein the Risley pair of prisms are adapted to be independently rotated about a common axis to change a line of sight (LOS) through both of the prisms,
wherein a boresight of two widely separated wavelengths within the broad spectrum are achromatically corrected optimally over the FOR.

2. The conformal beam steering device according to claim 1, the pair of prisms being formed from a substrate material comprising KRS5.

3. The conformal beam steering device according to claim 1, each of the pair of prisms being isosceles prisms.

4. The conformal beam steering device according to claim 1, each of the pair of prisms being right triangle prisms defined by a hypotenuse-side, an adjacent side parallel to the common axis, and an opposite side normal to the common axis.

5. The conformal beam steering device according to claim 4, wherein the opposite side of each right triangle is positioned outboard the hypotenuse side.

6. The conformal beam steering device according to claim 1, the first prism being an isosceles prism and the second prism being a right triangle prism defined by a hypotenuse side, an adjacent side parallel to the common axis, and an opposite side normal to the common axis.

7. The conformal beam steering device according to claim 6, wherein the opposite side of the right triangle is positioned outboard the hypotenuse side.

8. The conformal beam steering device according to claim 1, further including a broad spectrum beam source.

9. The conformal beam steering device according to claim 1, further comprising a window adapted to be conformally integrated with the skin or body of a vehicle, wherein the window is arranged normal to the common axis.

10. A conformal beam steering device adapted to steer a line of sight beam from a broad spectrum over a significantly large field of regard (FOR), the size of the device being optimized to have a minimal volume and output window footprint area, the beam steering device comprising:
a first prism positioned inboard a second prism to form a Risley pair of prisms;
a first linear diffraction grating positioned inboard the first prism, the first linear diffraction grating having a grating surface disposed on an outboard side thereof;
a second linear diffraction grating positioned in between the first linear diffraction grating and the first prism, the second linear diffraction grating having a grating surface disposed on an inboard side thereof;
wherein the Risley pair of prisms are adapted to be independently rotated about a common axis to steer a field of view (FOV) of the device through the FOR,
wherein the linear diffraction gratings are adapted to be independently rotated about the common axis so that the boresight of two widely separated wavelengths within the broad spectrum are achromatically corrected optimally over the FOR.

11. The conformal beam steering device according to claim 10, the pair of prisms being formed from a substrate material comprising KRS5.

12. The conformal beam steering device according to claim 10, each of the pair of prisms being isosceles prisms.

13. The conformal beam steering device according to claim 10, each of the pair of prisms being right triangle prisms defined by a hypotenuse side, an adjacent side parallel to the common axis, and an opposite side normal to the common axis.

14. The conformal beam steering device according to claim 13, wherein the opposite side of each right triangle is positioned outboard the hypotenuse side.

15. The conformal beam steering device according to claim 10, the first prism being an isosceles prism and the second prism being a right triangle prism defined by a hypotenuse side, an adjacent side parallel to the common axis, and an opposite side normal to the common axis.

16. The conformal beam steering device according to claim 15, wherein the opposite side of the right triangle is positioned outboard the hypotenuse side.

17. The conformal beam steering device according to claim 10, further including a broad spectrum beam source.

18. The conformal beam steering device according to claim 10, further comprising a window adapted to be conformally integrated with the skin or body of a vehicle, wherein the window is arranged normal to the common axis.

19. A conformal beam steering device adapted to steer a line of sight beam from a broad spectrum over a significantly large field of regard (FOR), the size of the device being optimized to have a minimal volume and output window footprint area, the beam steering device comprising:
a first prism positioned inboard a second prism to form a Risley pair of prisms;
a variable pitch linear diffraction grating positioned inboard the first prism, the diffraction grating having a grating surface disposed on an outboard side thereof;
wherein the Risley pair of prisms are adapted to be independently rotated about a common axis to steer a field of view (FOV) of the device through the FOR,
wherein the variable pitch diffraction grating is adapted to be independently rotated about the common axis while also being electrically addressed so that the boresight of two widely separated wavelengths within the broad spectrum are achromatically corrected optimally over the FOR.

20. The conformal beam steering device according to claim 19, the pair of prisms being formed from a substrate material comprising KRS5.

21. The conformal beam steering device according to claim 19, each of the pair of prisms being isosceles prisms.

22. The conformal beam steering device according to claim 19, each of the pair of prisms being right triangle prisms defined by a hypotenuse side, an adjacent side parallel to the common axis, and an opposite side normal to the common axis.

23. The conformal beam steering device according to claim 22, wherein the opposite side of each right triangle is positioned outboard the hypotenuse side.

24. The conformal beam steering device according to claim 19, the first prism being an isosceles prism and the second prism being a right triangle prism defined by a hypotenuse side, an adjacent side parallel to the common axis, and an opposite side normal to the common axis.

25. The conformal beam steering device according to claim 24, wherein the opposite side of the right triangle is positioned outboard the hypotenuse side.

26. The conformal beam steering device according to claim 19, further including a broad spectrum beam source.

27. The conformal beam steering device according to claim 19, further comprising a window adapted to be conformally integrated with the skin or body of a vehicle, wherein the window is arranged normal to the common axis.
